(19) United States
(12) Patent Application Publication
(10) Pub. No.: US 2022/0270109 A1
(43) Pub. Date: Aug. 25, 2022

(54) PROCESS AUTOMATION USING ANALYSIS OF ENTERPRISE NETWORK

(71) Applicant: INTERNATIONAL BUSINESS MACHINES CORPORATION, Armonk, NY (US)

(72) Inventors: Radha Mohan De, West Bengal (IN); Amitabha Mitra, West Bengal (IN); Aditya Prasad Dutta, Bangalore (IN)

(21) Appl. No.: 17/183,892

(22) Filed: Feb. 24, 2021

(51) Int. Cl. G06Q 30/00; G06Q 30/02; G06Q 10/06; G06Q 10/10

(52) U.S. Cl. CPC G06Q 30/016; G06Q 30/0203; G06Q 10/0633; G06Q 10/107

(57) ABSTRACT

A method for task automation that includes selecting a task of process performed in a business to measure for automation suitability, and configuring an enterprise graph as a source for stakeholders in a business having a measurable affinity to the task. The method further includes scoring the stakeholders by affinity using the source provided from the enterprise graph, and clustering the stakeholders into groups scored by affinity to the task. The method can further include performing a survey including questions directed to a level of automation to the groups of stakeholders, and scoring results from the survey directed to the level of automation.

### BACKGROUND

The present invention generally relates to automation of tasks, and more particularly to automation of tasks by utilizing social networking information.

Enterprises have quickly adopted the enterprise social networking to capture social graph for its members to understand the professional cohesion among the leaders and their followers, to enforce democratization among its employees and to observe deep insights of the factors, which attributes most in growth of it. There are many solutions available to calculate the potentiality of an enterprise process for automation, which mostly takes care of technical feasibilities of the process. However, existing solutions do not consider the stakeholder's involvements in its operational model. The existing solutions do not consider how much resistance may be faced in the automated implementation of the process from its current stakeholders. But operational success of the automated process is mainly attributed to its longer duration, that would cause good return on investment (ROI) to enterprise and that is possible if and only current stakeholders cooperate this process conversion from its current form to automation.

### SUMMARY

In accordance with an embodiment of the present invention, a computer-implemented method for task automation is provided that includes selecting a task of a process for a business to measure for automation suitability, and configuring an enterprise graph as a source for stakeholders in a business having a measurable affinity to the task. The method may further include scoring the stakeholders by affinity using the source provided from the enterprise graph, and clustering the stakeholders into groups scored by affinity to the task. The method can further include performing a survey including questions directed to a level of automation to the groups of stakeholders, and scoring results from the survey directed to the level of automation for the task to increase efficiency of the process performed in the business.

In another aspect, a system for task automation is described that includes a task selection interface for selecting a task of a business to measure for automation suitability; and an enterprise graph as a source for stakeholders in a business having a measurable affinity to the task. The system may further include a sentiment score engine for scoring the stakeholders by affinity using the source provided from the enterprise graph. In some embodiments, the system further includes a survey generator for performing a survey including questions directed to a level of automation to the groups of stakeholders, and a report generator for scoring results from the survey directed to the level of automation for the task to increase efficiency of the process performed in the business.

In yet another aspect, a computer program product for process automation is provided that includes a computer readable storage medium having computer readable program code embodied therewith, the program instructions executable by a processor to cause the processor to select, using the processor, a process of a business to measure for automation suitability to a business; and configure, using the processor, an enterprise graph as a source for stakeholders in a business having a measurable affinity to the process. The computer program product may further score, using the processor, the stakeholders by affinity using the source provided from the enterprise graph; and cluster, using the processor, the stakeholders into groups scored by affinity to the process. Additionally, the computer program product can perform, using the processor, a survey including questions directed to a level of automation to the groups of stakeholders, and score, using the processor, results from the survey directed to the level of automation.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block/flow diagram illustrating a method for guiding design thinking for task automation using a social enterprise graph, in accordance with one embodiment of the present disclosure.

FIG. 2 is a block/flow diagram illustrating a system for guiding design thinking for task automation using a social enterprise graph, in accordance with one embodiment of the present disclosure.

FIG. 3 is an illustration of a template for collecting stakeholder affinity and technical feasibility for a chosen task and its sub-task for enterprise automation, in accordance with one embodiment of the present disclosure.

FIG. 4 is a block diagram illustrating a system that can incorporate the system for a series of questions from a presentation that is depicted in FIG. 5, in accordance with one embodiment of the present disclosure.

FIG. 5 depicts a cloud computing environment according to an embodiment of the present disclosure.

FIG. 6 depicts abstraction model layers according to an embodiment of the present disclosure.

### DETAILED DESCRIPTION

The methods, systems and computer program products provide for conducting a guided design thinking workshop using outcomes of prior analysis over derived social graph from an enterprise social network. In some embodiments, “enterprise social networks” focus on the use of online social networks or social relations among people who share business interests and/or activities. Enterprise social networking is often a facility of enterprise social software that encompasses modifications to corporate intranets (referred to as social intranets) and other classic software platforms used by companies to organize their communication, collaboration and other aspects of their intranets. Enterprise social networking may include the use of a standard external social networking service to generate visibility for an enterprise. However, the enterprise social network may be internal to a business. For example, an enterprise social network can a private, internal social network that businesses use to enable their team to communicate with each other across the company. It can incorporate some elements of team messaging, project management, task management, and collaboration tools into one platform. This can include more than just communication, but also organization charts and lists of access by participants to data, facilities, and tools through which job functions can be performed.

An enterprise “social graph” is a representation of the social network of a business, encompassing relationships among its employees, vendors, partners, customers, and the public.

The methods, systems and computer program processes consider processes for automating as nodes in enterprise social network (ESN) to draw graphs on its relationship dynamics with its stakeholders and organization, which is cross validated in a design thinking workshop, guided by the method generated framework described herein. Processes with high priority to organization (enterprise) and scores low empathy index from its stakeholders, are best candidate for automation.

Enterprises have quickly adopted the enterprise social networking to capture social graph for its members to understand the professional cohesion among the leaders and their followers, to enforce democratization among its employees and to observe deep insights of the factors, which attributes most in growth of it. The methods, systems and computer program processes a set of new entities as nodes in enterprise social networks to mingle them into process of drawing social graph and observe their role in it. Some selected processes and enterprise itself are these two new entities to take part in generating enterprise social graph, since the selected processes would be potential candidate for improvement, automation or alleviation (abolishing) if they yield some preconfigured scores.

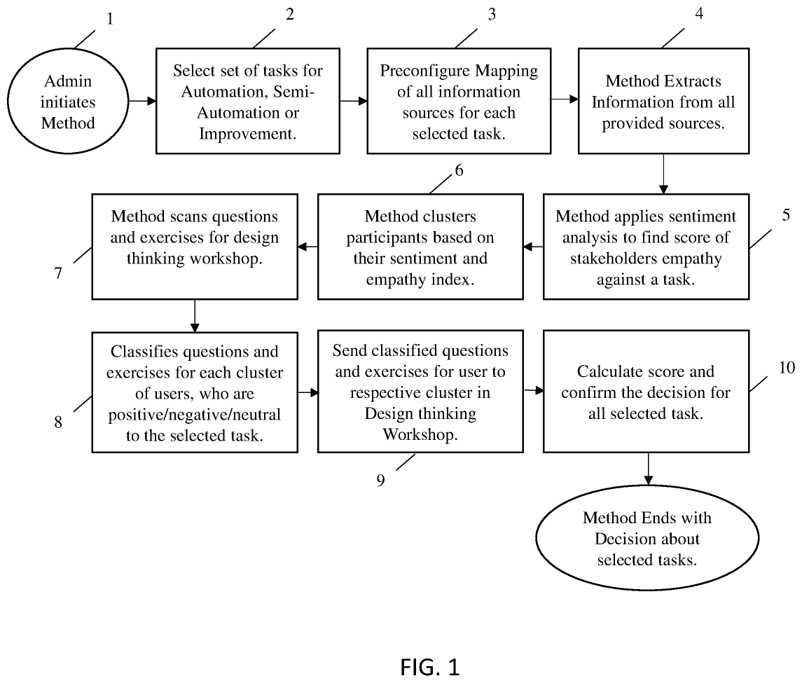

The approach of some embodiments of the methods, systems and computer program products of the present disclosure apply cognitive technology to guide a design thinking workshop using derived knowledge from enterprise social graph to derive the potential candidate tasks for automating to minimize the influence of its stakeholders, while they are possessing below threshold affinity about their owned tasks. The method, systems and computer program products of the present disclosure are now described in greater detail with reference to FIGS. 1-6.

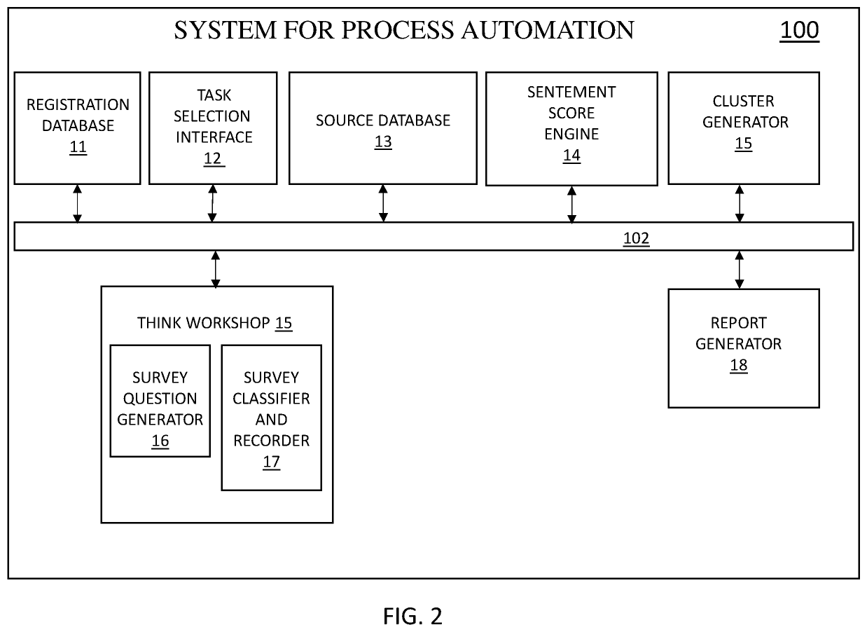

FIG. 1 illustrates a method for guiding design thinking for process automation using a social enterprise graph. FIG. 2 illustrates a system for guiding design thinking for process automation using a social enterprise graph.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

FIG. 1 illustrates some embodiments of the proposed method. Design thinking programs can be helpful for any process modification in a structured enterprise, where stakeholder's and owner's empathies about a task get captured in a systematic template to derive scores for the candidate processes. Hence these candidate tasks are selected for removal, improvement or automation based on scores for each task.

The method depicted in FIG. 1, as well as the system illustrated in FIG. 2, can contribute to the current practice of design thinking by applying the technique of cognitive analysis over a derived social graph from a social enterprise network. The cognitive analysis includes analysis of some selected candidate tasks for automation and organization, along with the stakeholders that will be using those tasks. The stakeholders can include the process owner that includes the task being considered for automation, application owner, client and process executers of the tasks that are being considered for automation. The analysis considers the stakeholders affinity to automation of a process. The term “affinity” denotes a liking or sympathy of tasks of the process by the stakeholders.

The tasks with high importance to its organization and low affinity from its stakeholders are most potential candidates for automation. Tasks having a moderate affinity of the stakeholders for a process with high importance from organization are candidates for improvements. Finally, tasks with low importance from organization and lowest affinity from its stakeholders are candidates for abolishing. Abolishing can mean either elimination from the possibility of automation/improvements or can mean that the organization discontinues use of the process.

Referring to FIG. 1, the method may begin at step 1 with a registration step. Step 1 includes an administrator for the method initiating the method for guiding design thinking for process automation using a social enterprise graph. The methods described herein can collect user data. Therefore, the registration step not only includes providing the user access to method for guiding design for process automation using a social enterprise graph in accordance with the methods disclosed herein, but also includes the users giving permission or not giving permission for the methods and systems to access the user's data, e.g., personal data. Not only is the administrator registering, but stakeholders in the company also register giving permission or not giving permission for the methods and systems to access the users data, e.g., personal data.

Aspects of the methods disclosed herein provide for data sharing. For example, data sharing can be used to provide the stakeholder communications data relative to the tasks to be automated. Users having the option of participating in this aspect, e.g., opting-in, or not participating, e.g., opting-out. To the extent implementations of the invention collect, store, or employ personal information provided by, or obtained from, individuals (for example, statements directed to affinity of stakeholders for a process, etc.), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information. Further, the user, e.g., administrator and/or stakeholders, may change their data sharing status, e.g., whether they opt-in to the system or opt-out of the system, at any time.

Referring to FIG. 2, the registration step may through a registration interface 11 with the system 100 for guiding design thinking for process automation using a social enterprise graph. The registration interface 11 may be an input for data. The data may be entered through a graphic user interface of a device communicating with the registration interface 11 of the system 100 for guiding design thinking for process automation using a social enterprise graph. The graphic user interface can be the mechanism by which data directed to registration and user consent can be inputted into the system, e.g., by text entry (a keyboard), touch based data entry (touch screen), upload of data (e.g., uploading data files) and voice command (using natural language processing).

Referring to block 2, the method may further include selecting a task for automation, semi-automation or improvement. The task can be part of a process for any type of industry. In one example, the task can be for the lending industry. The tasks can include loan origination, underwriting, securitization, and collection and recovery. In some embodiments, the method can further includes sub-tasks that can be automated. A task that is semi-automated can be a task in which some of the sub tasks are automated, but not all of the sub tasks are automated. For example, a task, such as loan origination can include sub tasks selected from the group that includes credit check, background verification, credit sanctioning, loan disbursement, know your customer (KYC) procedures and combinations thereof.

Referring to FIG. 2, the step may through a task selective interface 12 with the system 100 for guiding design thinking for process automation using a social enterprise graph. The task selection interface 12 may be an input for data. The data may be entered through a graphic user interface of a device communicating with the task selection interface 12 of the system 100 for guiding design thinking for process automation using a social enterprise graph. The graphic user interface can be the mechanism by which data directed to registration and user consent can be inputted into the system, e.g., by text entry (a keyboard), touch based data entry (touch screen), upload of data (e.g., uploading data files) and voice command (using natural language processing).

Referring to block 3 of FIG. 1, the method can continue with a preconfigure mapping of all information sources for each selected task. In some embodiments, the preconfiguring of the source of information for each selected task, can include sources selected from the group consisting of incident analysis system, blogs, emails, meeting systems and communication systems. It is noted that these sources represent only a sample of the type of sources that can be used with the method. Any source that can provide data directed to affinity of the stakeholders is suitable for this step of the task. Any source that can provide data directed to the importance of a task is suitable for use with this step of the task. The sources can be inputted into the system by the administrator during commissioning of the system. The sources can be specific to the organization for which the automation guidance is desired.

The data from the preconfigured mapping may be scored in the source database 13 of the system 100 for guiding design thinking for process automation using a social enterprise graph. The storage may include any type of memory that is searchable and can allow for data to be extracted from. For example, the hardware storage may include a hard disk, a random access memory (RAM), a read-only memory (ROM), an erasable programmable read-only memory (EPROM or Flash memory), a static random access memory (SRAM) or combination thereof. The memory for storing the registration database 51 may also be provided by cloud based memory.

Block 3 can generate the social enterprise graph through which task automation can be evaluated through stakeholder affinity.

Referring to block 4, the method can continue with extracting information from all the provided sources. In some embodiments, the methods, systems and computer program products can scan information sets to apply social graph generating methods by considering tasks as most influential node, while tasks for the enterprise and its stakeholders are members in enterprise social network to allow the method to determine participants with positive, neutral and negative edge of each participants and calculate social networking potential coefficient of the process. In some embodiments, the methods, systems and computer programs employ a crawler to extract information from the sources provided for data. A crawler is a computer program that automatically searches documents. In some embodiments, a crawler looks for information within a document, which it assigns to certain categories, and then indexes and catalogues it so that the crawled information is retrievable and can be evaluated.

In some embodiments, the methods, systems and computer program products scan these information sets to apply signed social graph generating method by considering the task as the most influential node, while process owning enterprise and its stakeholders are members in enterprise social network to allow the system to find participants with positive, neutral and negative edge of each participants and calculate social networking potential coefficient of the process.

Referring to block 5, in some embodiments, the method further includes applying sentimental analysis to find score of stakeholders empathy, e.g., affinity, against and/or for a process, e.g., a process to be automated. The term “sentiment” denotes style, tone, word usage in a communication. For example, the method, system and computer program products can check how strong the stakeholders are attached with the selected process in terms of sentiment or empathy through their communications. For example, do the stakeholders promptly reply all queries about the process, are they all take part in meetings related to process, are they solve issues in process as soon as tickets are assigned to them or it brings lots of service level agreement (SLA) breaches, what customer satisfaction index about stakeholders interaction with customer about the process. The communications can be between different stake holders, e.g., via messaging systems based on text in real time. The communications can also be emails.

Referring to FIG. 2, blocks 4 and 5 of the method depicted in FIG. 1 may be performed by a sentiment score engine 14 of the system 100 for guiding design thinking for process automation using a social enterprise graph. As noted above, extraction of data from communications in sources may be provided by crawler. The sentiment score engine 14 may include a special purpose hardware processor and memory, in which the memory includes instructions for analyzing data from the sources, e.g., portions of communications directed to the affinity of the stakeholders for the task. The sentiment analysis engine may use one or more dictionaries of base patterns to analyze the text. Text analytics may be used in environments in which linguistic grammars, dictionaries, and parsing rules are utilized to help discover meaning of text sources. In embodiments in which the sources are voice based, a conversion to text may be provided by natural language processing.

It is noted that sentiment analysis is not limited to just text based analysis. In some modes of communication, emoticons, emojis and graphical indicators are provided noting a stakeholders affinity, i.e., liking, for a communication. This can also be used to score sentiment to a process, when the communication is discussing or related to the process or type of process which is being evaluated for automation.

Referring to FIG. 1, the method can further cluster participants, e.g., stakeholders, based on their sentiment and empathy index. In one embodiment, a cluster is generated as result of the block 4 with participants, e.g., stakeholders, who are with same edge value. The sentiment and empathy index is scored at block 4. The methods, systems and computer program products can create a social graph for a set of preselected processes to display the Social Networking Potential (SNP) coefficient for its participants (who are stakeholders of the selected processes) and process owning organization applying signed graph and find positive, negative and neutral set of participants, depending on their positive or negative edges. The source of deriving SNP coefficient for candidate processes are the communication artefacts and sources from its stakeholders and owning enterprise, which will yield positive and negatives edges to represent relationship dynamics of the processes and its stakeholders and owning enterprise. The result of this exercise generates clusters of participants (stakeholders and organization) for each process with negative, positive and neutral relationship dynamics, with prior assumption of selected process as major influencer in graph.

Referring to FIG. 2, the clusters of scored stakeholders that results from the scoring of block 4 may be stored in a database of users for a scored cluster 15. The database may be provided by any form of memory as described above.

The method can continue to block 6, in which the method clusters participants based on their sentiment and empathy index.

Block 7 of the method depicted in FIG. 1 can include a scan of questions and exercises for a design thinking workshop 15. The design thinking workshop 15 can be provided by at least a design survey generator 15 for the system 100 for guiding design thinking for task automation using a social enterprise graph. The design survey generator 16 can provide questions directed to extracting automation data for tasks to specific clusters of scored stakeholders stored in the scored cluster database 15. For example, the method may include finding a set of questions and other exercises for a design thinking workshops 15 to classify them to work over specific cluster of participants, in ways like below:

1. Questions and Exercises to understand how negative its stakeholders are for a task, which is important for organization. The aim is to automate the process to save costs and time for organization.

2. Questions and Exercises to understand how neutral its stakeholders are for a task, which is moderately important for organization. The aim is to improve or automate the task to save costs and time for organization.

3. Questions and Exercises to understand how positive its stakeholders are for a task, which is extremely important for organization. The aim is to leave the process in its current form.

Based on the output of above 3 sets of questions, a task can be automated to semi-automated or can be left in its present form with a small extent of improvement.

Referring to FIG. 1, at block 8, the method further classifies the questions and exercises from block 7 for each cluster of users stored in the database of users for scored clusters 14, which was scored and grouped in block 6. For example, a survey classifier and recorder 17 of the design thinking workshop 15 can regulate its participants into three groups to capture their empathy scores by shooting certain set of questions and exercises over specific group of its participants, as proposed by enterprise graph analysis exercise on same set of participants using their communication analysis. Groups will be divided into groups with negative, positive and neutral groups of stakeholders for a selected task, which is either potential candidate for automate, improve or abolish.

Block 9 of FIG. 1 includes providing (also referred to as to shoot) classified questions (as provided in block 8) for users belong to respective clusters. In some embodiments, the methods, systems and computer program products scan the set of questions and exercises and classify those to shoot over a set of specific edge-based participants to understand their affinity for a selected process, for which they are stakeholders and organization has some importance for, e.g., the stakeholders and organization may benefit or not benefit for automation of the process. Method applies sentiment analysis technique over questions and description of the exercises, meant for design thinking workshop.

The questions and exercise for design thinking workshop 15 will be arranging in a way to be delivered to its participants so that at least one of the following output can occur:

A) Task selected for automation will get high favor from organization and disfavor from its participants to enhance its potential to deal it manually. The objective of this exercise can be to determine how strong the position is from the stakeholders in favor of automation of a task.

B) Task selected for improvement (partially automating) will get high favor from organization and neutral attitude (group of unbalanced participants are high in number, who are likely to incline in favor or disfavor of the process automation) from its participants. The objective of this exercise can be to determine how strong the position is from the stakeholders in favor of semi-automation of a task.

C) Process selected for abolishing will get low favor or no favor from organization and almost no favor from its participants as well. The objective of this exercise can be to determine how strong the position is from the stakeholders in favor of abolishing (discontinuing) a process.

Blocks 7, 8 and 9 of the method may be provided by the design thinking workshop 15 of the system 100 for guiding design thinking for task automation using a social enterprise graph that is depicted in FIG. 2.

Referring to FIG. 1, the methods, systems and computer program products can generate an automation quotient for each selected task from above exercises. Block 10 includes calculate a score and confirm the decision about automating selected tasks. Automation quotient is likely to be of following types:

i) High automation quotient when the social graph yields very positive edge from owning organization for a selected task and very negative edge from its stakeholders. A similar output can also result from face to face interaction in the design thinking workshop.

ii) Moderate automation quotient when the social graph yields almost equal group of participants with negative and positive edge value for a selected task, which is having positive edge owning organization.

iii) Negative automation quotient when social graph yields almost all negative edge value for its participants and low affinity from its owning enterprise.

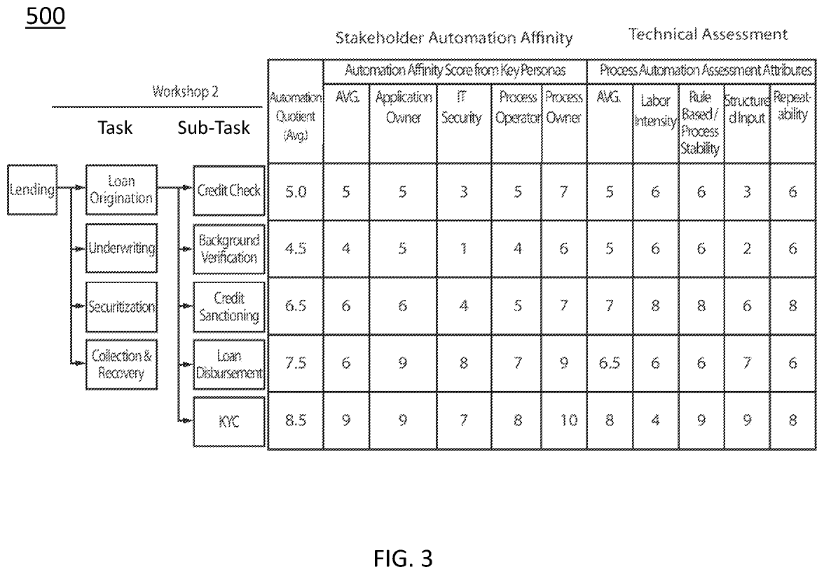

Tasks with high automation quotient can be selected for automation. Block 10 of the method depicted in FIG. 1 may be performed by a report generator 18. The report generator 18 may deliver a report on automation to the display of a user, e.g., stakeholder. FIG. 3 is an indicative template 500 for collecting stakeholder affinity and technical feasibility for a chosen task and its sub-task for enterprise automation.

The result of the methods, systems and computer program products of the present disclosure is automation quotient in use case (or selected task) specific exercise, which cross validates the stakeholder's behavior in social graph analysis and face to face design thinking workshops. In some embodiments, the methods, systems, and computer program products list the candidate tasks for automation, which are directly proportional to organization affinity and inversely proportional to its stakeholders.

FIG. 2 illustrates one embodiment of the system 100 for task automation that can be used with the method described above with reference to FIG. 1. The system 100 for task automation includes a task selection interface 12 for selecting a task of a business to measure for automation suitability to a business; and an enterprise graph as a source for stakeholders in a business having a measurable affinity to the task. The enterprise graph may be provided by the source database 13. The system may further include a sentiment score engine 14 for scoring the stakeholders by affinity using the source provided from the enterprise graph. In some embodiments, the system further includes a survey generator 16 for performing a survey including questions directed to a level of automation to the groups of stakeholders, and a report generator 18 for scoring results from the survey directed to the level of automation. Each of the task selection interface 12, the source database 13, the sentiment score engine 14, survey generator 16 and the report generator 18 may be interconnected and operatively coupled to a system bus 102. The bus 102 interconnects a plurality of components as will be described herein.

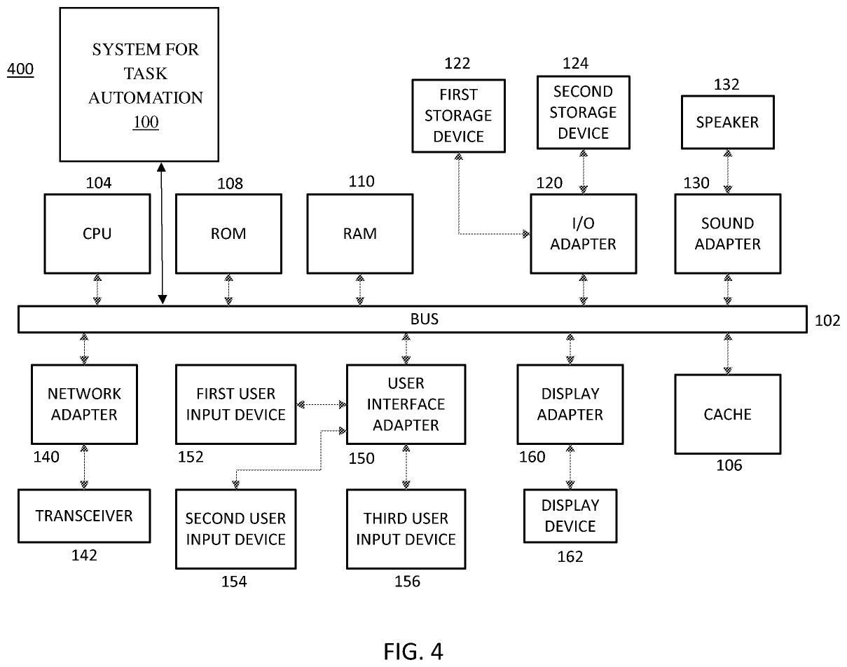

The system 100 for process automation may be integrated into the processing system 400 depicted in FIG. 4. The processing system 400 includes at least one processor (CPU) 104 (also referred to as hardware processor) operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102. The bus 102 interconnects a plurality of components as will be described herein.

In one embodiment, the automation of the task is the preparation of a loan acceptance letter in the loan granting process of a banking institution. This may be in response to a loan applicant submitting an application to a banking institution. In this example, the systems and method may determine that the task of preparing a letter to the application indicating their acceptance is something having a low affinity for those workers for the administrators of the loaning business. However, identifying to the applicant that they qualify for a business is essential to the banking institution loaning processes. In response to the identification of the task of preparing a letter as something suitable for automation, the systems, methods and computer program products can automatically launch an application that automates the preparation of the letter for review of a loan officer. Additionally, the application can consider other factors in determining acceptance, such as analysis of a credit rating or analysis of other credit worthiness features for the application. These steps can be automated with the task of preparing the acceptance letter for review by the loan officer.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

The system 400 depicted in FIG. 4, may further include a first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 152, 154, and 156 can be the same type of user input device or different types of user input devices. The user input devices 152, 154, and 156 are used to input and output information to and from system 400.

Of course, the processing system 400 may also include other elements (not shown), as readily contemplated by one of skill in the art, as well as omit certain elements. For example, various other input devices and/or output devices can be included in processing system 400, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 400 are readily contemplated by one of ordinary skill in the art given the teachings of the present invention provided herein.

The present invention may be a system, a method, and/or a computer program product at any possible technical detail level of integration. The computer program product may include a computer readable storage medium (or media) having computer readable program instructions thereon for causing a processor to carry out aspects of the present invention.

For example, the present disclosure provides a computer program product including a non-transitory computer readable storage medium having computer readable program code embodied therein for providing a plurality of questions from a presentation. In some embodiments, the computer program product for process automation includes a computer readable storage medium having computer readable program code embodied therewith, the program instructions executable by a processor to cause the processor to select, using the processor, a process of a business to measure for automation suitability to a business; and configure, using the processor, an enterprise graph as a source for stakeholders in a business having a measurable affinity to the process. The computer program product may further score, using the processor, the stakeholders by affinity using the source provided from the enterprise graph; and cluster, using the processor, the stakeholders into groups scored by affinity to the process. Additionally, the computer program product can perform, using the processor, a survey including questions directed to a level of automation to the groups of stakeholders, and score, using the processor, results from the survey directed to the level of automation.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The methods of the present disclosure may be practiced using a cloud computing environment. Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

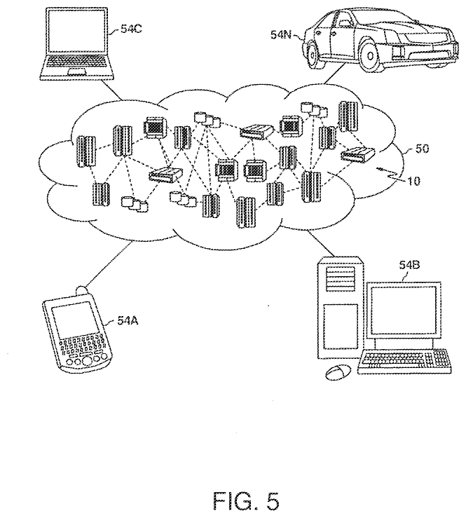

Referring now to FIG. 5, illustrative cloud computing environment 50 is depicted. As shown, cloud computing environment 50 includes one or more cloud computing nodes 51 with which local computing devices used by cloud consumers, such as, for example, mobile and/or wearable electronic devices 54A, desktop computer 54B, laptop computer 54C, and/or automobile computer system 54N may communicate. Nodes 110 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 51 and cloud computing environment 50 can communicate with any type of computerized device over any type of network and/or network addressable connection (e.g., using a web browser).

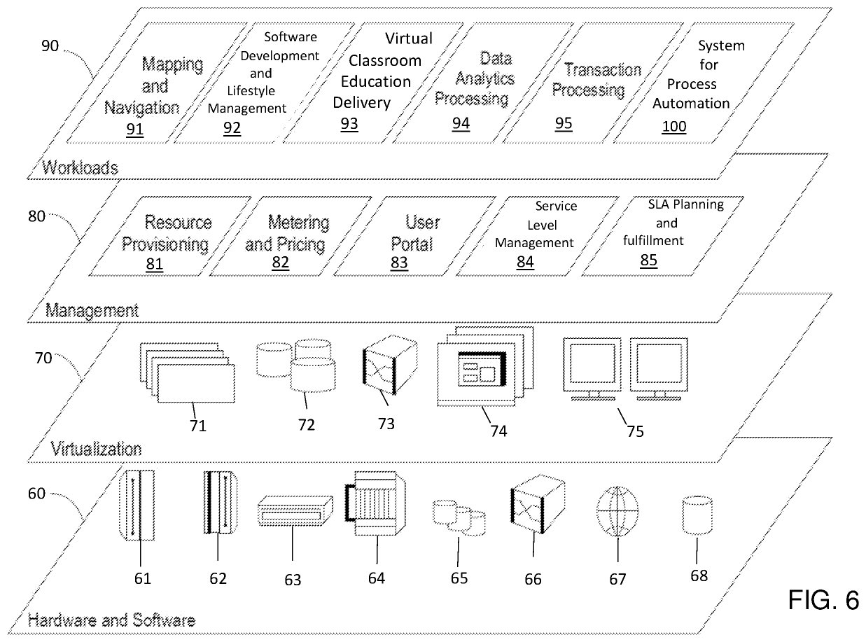

Referring now to FIG. 6, a set of functional abstraction layers provided by cloud computing environment 50 (FIG. 1) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and system 100 for process automation, which is described with reference to FIGS. 1-3.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

Having described preferred embodiments of process automation using analysis of enterprise network, it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for task automation comprising:
selecting a task of a process performed in a business to measure for automation suitability;
configuring an enterprise graph as a source for stakeholders in a business having a measurable affinity to the task;
scoring the stakeholders by affinity using the source provided from the enterprise graph;
clustering the stakeholders into groups scored by affinity to the task;
performing a survey including questions directed to a level of automation to the groups of stakeholders; and
scoring results from the survey directed to the level of automation for the task to increase efficiency of the process performed in the business.

2. The computer-implemented method of claim 1, including launching an application to automate the task having a score above a threshold for the increase of efficiency of the process.

3. The computer-implemented method of claim 1, wherein the source provided by the enterprise graph is selected from the group consisting of incident analysis system, blogs, emails, meeting systems, communication systems and combinations thereof.

4. The computer-implemented method of claim 1, wherein the scoring the stakeholders by affinity comprises sentiment analysis.

5. The computer-implemented method of claim 1, wherein the scoring results directed to the level of automation include a value for whether the process is important to a business function separate from stakeholder affinity.

6. The computer-implemented method of claim 1, wherein the performing the survey comprises questions directed to clusters of stakeholders to determine stages of automation for the task including a first task type being suited for automation, a second task type for semi-automation, and a third task type for being abolished.

7. The computer-implemented method of claim 6, wherein the semi-automation for the task includes automation of at least one sub-task of a task, but does not include automation of all sub-tasks.

8. The computer-implemented method of claim 1, wherein the business is a money lending business, and the task for automation is selected from the group consisting of a loan origination task, an underwriting task, a securitization task, collection task and a recovery tasks.

9. The computer-implemented method of claim 1, wherein the scoring of the stakeholders comprises analysis of response times to communications about the process, analysis of attendance to meetings by the stakeholders related to process, a customer satisfaction index about stakeholders interaction with customer or combinations thereof.

10. A system for task automation comprising:
a process selection interface for selecting a task of a process performed in a business to measure for automation suitability;
an enterprise graph as a source that scores stakeholders in a business having a measurable affinity to the process;
a sentiment score engine that scores the stakeholders by affinity using the source provided from the enterprise graph;
a survey generator that performs a survey including questions directed to a level of automation to the groups of stakeholders; and
a report generator that scores results from the survey directed to the level of automation for the task to increase efficiency of the process performed in the business.

11. The system of claim 10, wherein the source provided by the enterprise graph is selected from the group consisting of incident analysis system, blogs, emails, meeting systems, communication systems and combinations thereof.

12. The system of claim 10, wherein the scoring the stakeholders by affinity comprises sentiment analysis.

13. The system of claim 10, wherein scoring results directed to the level of automation include a value for whether the task is important to a business function separate from stakeholder affinity.

14. The system of claim 10, wherein performing the survey comprises questions directed to clusters of stakeholders to determine stages of automation including a first task type being suitable for automation, a second task type for semi-automation, and a third task type for being abolished.

15. The system of claim 10, wherein the scoring of the stakeholders comprises analysis of response times to communications about the task, attendance to meetings by the stakeholders related to the task, a customer satisfaction index about stakeholders interaction with customer or combinations thereof.

16. The system of claim 10, wherein semi-automation includes automation of at least one sub-task of the task, but does not include automation of all sub-tasks.

17. A computer program product for process automation, the computer program product comprising a computer readable storage medium having computer readable program code embodied therewith, the program instructions executable by a processor to cause the processor to:
select, using the processor, a task of a process performed in a business to measure for automation suitability;
configure, using the processor, an enterprise graph as a source for stakeholders in a business having a measurable affinity to the task;
score, using the processor, the stakeholders by affinity using the source provided from the enterprise graph;
cluster, using the processor, the stakeholders into groups scored by affinity to the task;
perform, using the processor, a survey including questions directed to a level of automation to the groups of stakeholders; and
score, using the processor, results from the survey directed to the level of automation for the task to increase efficiency of the process performed in the business.

18. The computer program product of claim 17, wherein the source provided by the enterprise graph is selected from the group consisting of incident analysis system, blogs, emails, meeting systems, communication systems and combinations thereof.

19. The computer program product of claim 17, wherein the scoring the stakeholders by affinity comprises sentiment analysis.

20. The computer program product of claim 17, wherein scoring results directed to the level of automation include a value for whether the task is important to a business function separate from stakeholder affinity.
